(19) United States
(12) Patent Application Publication
(10) Pub. No.: US 2010/0005262 A1
(43) Pub. Date: Jan. 7, 2010

(54) Information Processing Apparatus, Data Restoring Method of Information Processing Apparatus, and Data Restoring Program of Information Processing Apparatus

(75) Inventor: Michiaki Eri, Hino-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/413,064

(22) Filed: Mar. 27, 2009

(30) Foreign Application Priority Data
Jul. 2, 2008 (JP) 2008-173579

(51) Int. Cl. G06F 12/16; G06F 12/02

(52) U.S. Cl. 711/162; 711/115; 711/E12.008; 711/E12.103

(57) ABSTRACT

According to the present invention, an information processing apparatus includes: a first storage module; a second storage module; a first acquiring module configured to acquire data from the first storage module when a failure occurs; a determination module configured to determine whether the data acquired by the first acquiring module includes system data having a possibility of changing system operation; and a first copying module configured to copy the data to the second storage device with a destination information, wherein, when the determination module determines that the data does not include the system data, a previous location of the data before occurrence of the failure is set as the destination information, and wherein, when the determination module determines that the data includes the system data, a certain location in the first storage module is set as the destination information.

### CROSS-REFERENCE TO RELATED APPLICATIONS

This application is based upon and claims the benefit of priority from Japanese Patent Application No. 2008-173579, filed Jul. 2, 2008, the entire contents of which are incorporated herein by reference.

### BACKGROUND

1. Field

The present invention relates to an information processing apparatus, a data restoring method of an information processing apparatus, and a data restoring program of an information processing apparatus which make it possible to restore internal data reliably in the event of an OS failure.

2. Description of the Related Art

In general, the operating system Thereinafter referred to as OS) of a computer is stored in a partition of a main hard disk drive. When the basic input/output system (hereinafter referred to as BIOS) of the computer is activated, the partition of the main hard disk drive is searched for the OS via an IDS (integrated drive electronics) or SCSI (small computer system interface) connection interface and the OS is booted. If part of the data of the OS is damaged in an unexecutable manner, the computer cannot execute a command or software relating to the damage.

One of most common countermeasures against such trouble is to back up the OS in a flexible disk or a CD-ROM. Where the main board of a computer cannot boot the OS from the hard disk drive, a disc containing the backup OS is used to boot the computer.

The method of using an additional storage device for storage of the OS of a computer is inconvenient to a user who is not familiar with the manipulation environment of the OS and file types of the computer. Therefore, when the OS of a computer is damaged and no usable backup OS is available, it may be necessary for an ordinary user to consult the original manufacturer. However, there is a disadvantage that sending a computer to the manufacturer or consulting an expert requires much time and cost.

In view of the above, to give users a complete and more convenient OS, a method for restoring a damaged OS or important files immediately to allow the computer to boot up normally has been proposed (see JP-A-2003-76614). In this method of backing up and restoring data in a hard disk drive, first, usable empty areas of each partition of the hard disk drive are detected while the computer system is in operation. A particular storage device is used for backing up important files of the OS in usable empty areas. When the OS is damaged and cannot be booted, the backup OS data are immediately restored being supplied to original storage locations. A damaged file is restored and the OS is booted normally by this method.

The method of backing up important files in empty areas of the hard disk drive while the OS is in operation is useful in the case where it can be expected that the OS may be damaged and the OS can be backed up in advance. However, this method has a disadvantage that a damaged file cannot be restored in the case where the OS is damaged in an unexpected situation and important files have not been backed up.

Furthermore, if damage of an OS is restored using a backup of internal data by restoring files at the same locations using the same names through overwriting, even files to be used by the system may be altered contrary to a user's intention to save data, resulting in trouble in operation of the system itself.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an exemplary system configuration of a data restoring system to which an information processing apparatus according to the present invention is applied.

FIG. 2 is an exemplary block diagram of the information processing apparatus according to the invention.

FIG. 3 is an exemplary schematic chart showing a procedure for restoring internal data using a failure recovery OS when a failure has occurred in an ordinary OS of the information processing apparatus according to the invention.

FIG. 4 is a flowchart of a data saving process which is executed by the information processing apparatus according to the invention.

FIG. 5 is an exemplary schematic chart showing the data saving process and a data restoration process which are executed by the information processing apparatus according to the invention.

FIG. 6 is an exemplary flowchart of the data restoration process which is executed by the information processing apparatus according to the invention.

FIG. 7 shows an exemplary displayed picture of a list of restored files.

### DETAILED DESCRIPTION

Various embodiments according to the invention will be described hereinafter with reference to the accompanying drawings. In general, according to one embodiment of the invention, an information processing apparatus includes: a first storage module; a second storage module; a first acquiring module configured to acquire data from the first storage module when a failure occurs; a determination module configured to determine whether the data acquired by the first acquiring module includes system data having a possibility of changing system operation; and a first copying module configured to copy the data to the second storage device with a destination information, wherein, when the determination module determines that the data does not include the system data, a previous location of the data before occurrence of the failure is set as the destination information, and wherein, when the determination module determines that the data includes the system data, a certain location in the first storage module is set as the destination information.

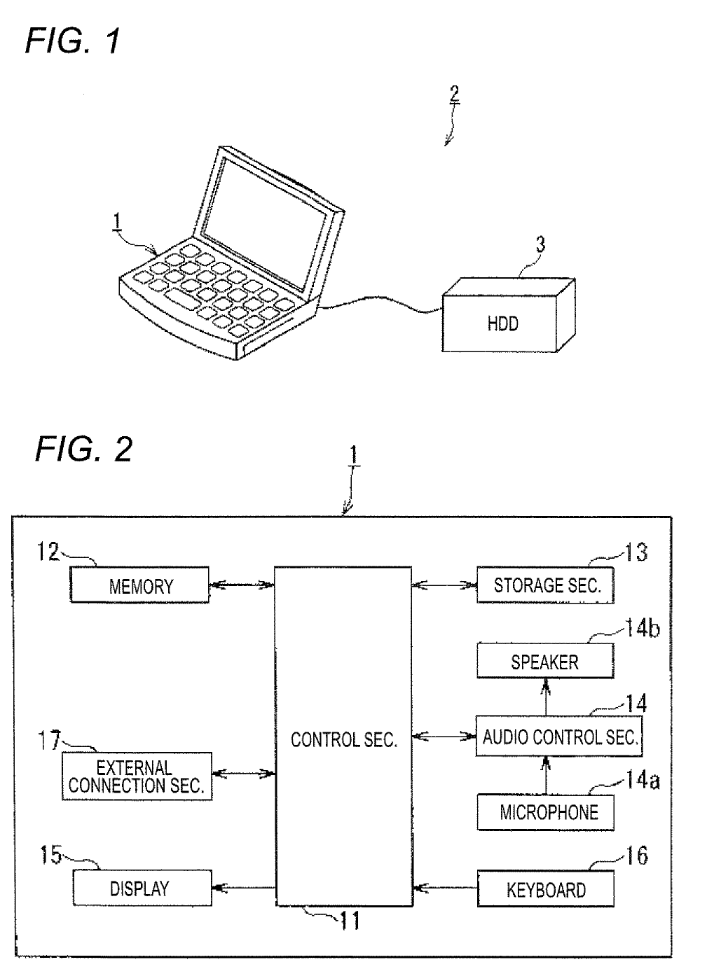

An information processing apparatus, a data restoring method of an information processing apparatus, and a data restoring program of an information processing apparatus according to an embodiment of the present invention will be hereinafter described with reference to the accompanying drawings. FIG. 1 shows a system configuration of a data restoring system 2 to which an information processing apparatus 1 according to the invention is applied. In the data restoring system 2, as shown in FIG. 1, the information processing apparatus 1 incorporating a storage device such as a hard disk drive and an external hard disk drive 3 are connected to each other so as to be able to communicate with each other. The external hard disk drive 3 is connected to the information processing apparatus 1 in a detachable manner.

FIG. 2 is a block diagram of the information processing apparatus 1. As shown in FIG. 2, the information processing apparatus 1, which is a general PC (personal computer), for example, is equipped with a control section 11, a memory 12, a storage section 13, an audio control section 14, a display 15, a keyboard 16, and an external connection section 17, which are connected to each other via a bus bridge, a controller etc. so as to be able to communicate with each other.

Equipped with a CPU (central processing module), the control section 11 controls the information processing apparatus 1 in a unified manner and performs data saving processing and data restoring processing (described later) and other various kinds of computation and control processing. Equipped with a RAM (random access memory), for example, the memory 12 stores data temporarily by serving as a work area for processing of the control section 11. Equipped with a storage device such as a hard disk drive and a ROM (read-only memory), the storage section 13 stores programs and data that are needed for processing of the control section 11.

The audio control section 14 is equipped with input/output interfaces for a microphone 14a and a speaker 14b which are incorporated in the information processing apparatus 1. Controlled by the control section 11, the audio control section 14 converts a voice picked up by the microphone 14a into a digital signal and sends it to the control section 11 and converts digital audio into analog audio and outputs it from the speaker 14b.

Equipped with an interface for the display 15, the control section 11 displays text data and image data on the display 15. Equipped with input interfaces for the respective keys of the keyboard 16, the control section 11 performs processing corresponding to a depressed key upon detecting its depression by a user.

The external connection section 17 is equipped with a data input/output interface for the external hard disk drive 3. When the external hard disk drive 3 is connected to the information processing apparatus 1, under the control of the control section 11 the external connection section 17 outputs data stored in the storage section 13 to the external hard disk drive 3 and inputs data stored in the external hard disk drive 3 to the storage section 13.

In the information processing apparatus 1, an OS (operating system) is stored in the storage section 13. The information processing apparatus 1 performs various kinds of processing under the control of the OS after it is booted by the control section 11. There was a disadvantage that the information processing apparatus 1 could not perform such processing if a failure occurs in the OS unless the information processing apparatus 1 used the invention. According to the invention, the information processing apparatus 1 is equipped with a failure recovery OS in addition to the OS for ordinary use (hereinafter referred to as “ordinary OS”). The failure recovery OS is stored in the storage section 13 in advance and is booted in response to, for example, a user input through the keyboard 16.

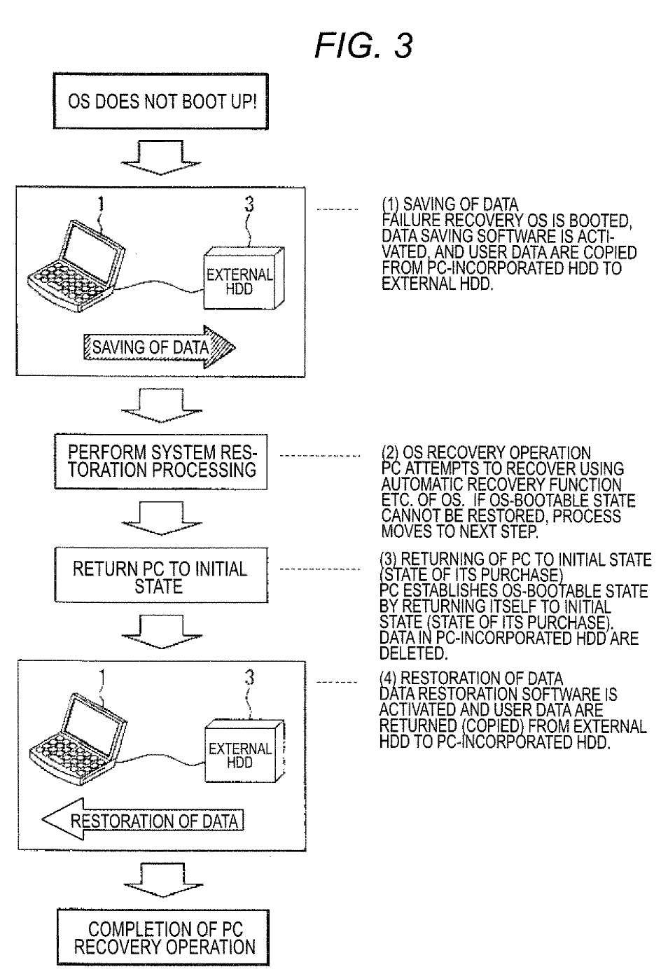

FIG. 3 is a schematic chart showing a procedure for restoring internal data of the information processing apparatus 1 using the failure recovery OS when a failure has occurred in the ordinary OS of the information processing apparatus 1. As shown in FIG. 3, when a failure has occurred in the ordinary OS of the information processing apparatus 1, the information processing apparatus 1 boots the failure recovery OS and data saving software in response to a user instruction. The external hard disk drive 3 is connected to the information processing apparatus 1, and data stored in the storage section 13 which is a storage device incorporated in the information processing apparatus 1 are output to the external hard disk drive 3 under the control of the data saving software. The external hard disk drive 3 stores these data in its own hard disk.

The information processing apparatus 1 attempts to recover from the failure in the ordinary OS under the control of the failure recovery OS. Upon recovery from the failure in the ordinary OS, the information processing apparatus 1 completes the recovery procedure and comes to operate under the control of the ordinary OS thus restored.

If the information processing apparatus 1 does not recover from the failure in the ordinary OS under the control of the failure recovery OS, the ordinary OS is returned to the initial state in response to a user instruction. In this case, all the data stored in the storage section 13 are deleted and pieces of setting information of the information processing apparatus 1 are deleted (setting states are returned to the initial states).

Then, the information processing apparatus 1 activates data restoration software of the failure recovery OS in response to a user instruction. The external hard disk drive 3 is connected to the information processing apparatus 1, and under the control of the data restoration software the data (saved data) stored in the external hard disk drive 3 are input to the storage section 13 which is a storage device incorporated in the information processing apparatus 1, whereby the data are restored. In this manner, when a failure has occurred in the ordinary OS, the information processing apparatus 1 recovers to the state before the occurrence of the failure under the control of the failure recovery OS.

It is assumed that, for example, Windows Vista (registered trademark) is installed as the ordinary OS and that Windows (registered trademark) RE is installed as the failure recovery OS in the information processing apparatus 1. The failure recovery OS may be stored in either the storage section 13 of the information processing apparatus 1 or the external hard disk drive 3. This embodiment will be described with an assumption that the failure recovery OS is stored in the storage section 13 of the information processing apparatus 1.

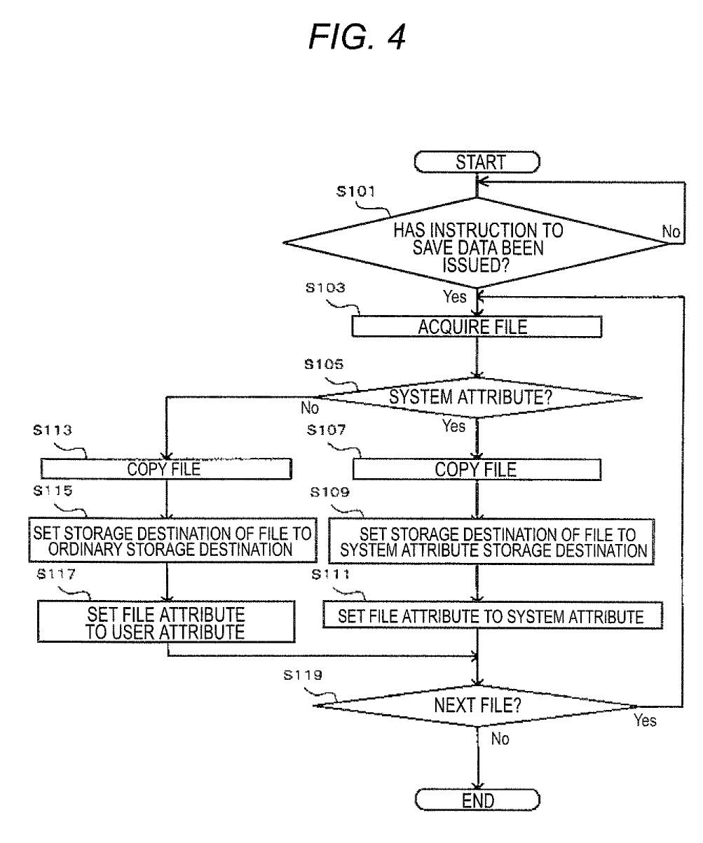

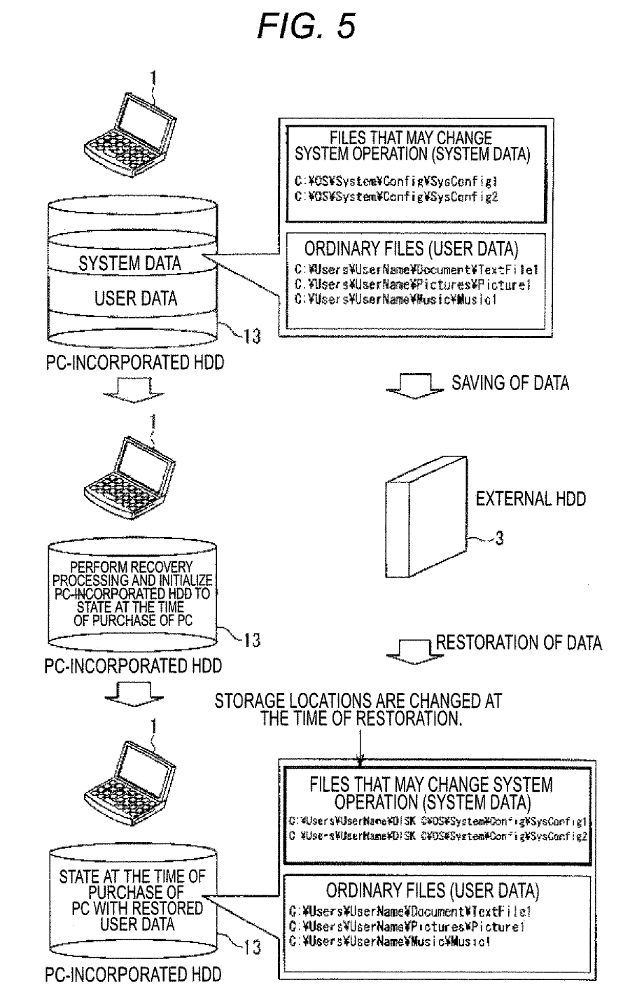

First, a data saving process which is executed by the information processing apparatus 1 when a failure occurs in the ordinary OS will be described with reference to a flowchart of FIG. 4 and a schematic chart of FIG. 5.

When a failure has occurred in the ordinary OS of the information processing apparatus 1, a user issues an instruction to save data stored in the storage section 13 by, for example, making an input through the keyboard 16. Therefore, at step S101, the control section 11 judges whether an instruction to save data has been issued by the user. If no instruction to save data has been issued by the user (S101: no), the control section 11 stands by until issuance of an instruction to save data.

If an instruction to save data has been issued by the user (S101: yes), the control section 11 boots the failure recovery OS and outputs (copies) data stored in the storage section 13 to the external hard disk device 3 under the control of the failure recovery OS. Copying internal data of the storage device 13 of the information processing apparatus 1 to the external hard disk device 3 in this manner makes it possible to restore the data that were stored in the storage device 13 using the data that have been stored in the external hard disk device 3 even if the data stored in the storage device 13 are deleted erroneously.

This operation will be described below in more detail. First, at step S103, the control section 11 acquires one of files stored in the storage section 13. Each file has attribute information indicting an attribute of the file such as a user attribute or a system attribute. The files having the user attribute are files that are mainly used by users, and flies having the system attribute are files that are used by the OS and may cause a change in the system operation. The term “change in the system operation” means that a situation that is not intended by a user is caused as exemplified by an event that the operation of the OS that is currently in operation is rendered unstable due to replacement of definition files that prescribe operation of the OS itself, an execution library, or the like. To store files having the system attribute in such a manner that they are discriminated from ordinary files (i.e., files having the user attribute), the control section 11 judges at step S105 whether the file acquired at step S103 has the system attribute.

If the file acquired at step S103 has the system attribute (S105: yes), at step S107 the control section 11 copies this file to the external hard disk device 3. To restore this file in the future at a location for system data, at step S109 the control section 11 sets the storage destination of the file to a system attribute storage destination. To restore this file in the future with the same attribute as at the time of the saving, at step S111 the control section 11 sets the attribute of the file to the system attribute.

If the file acquired at step S103 does not have the system attribute (S105: no), at step S113 the control section 11 copies this file to the external hard disk device 3. To return this file to the same location as at the time of the saving in restoring it in the future, at step S115 the control section 11 sets the storage destination of the file to an ordinary storage destination (i.e., a storage location before the failure). To restore this file in the future with the same attribute as at the time of the saving, at step S117 the control section 11 sets the attribute of the file to the user attribute.

After setting the file attribute at step S111 or S117, the control section 11 judges at step S119 whether the next file exists, that is, there remains a file that has not been subjected to steps S103-S117. If the next file exists (S119: yes), the process returns to step S103, where the control section 111 acquires the next file. Then, the control section 111 executes steps S105-S117 again. If no next file exists (S119: no), that is, if all the subject files stored in the storage section 13 have been subjected to steps S103-S117, the control section 11 finishes the data saving process.

FIG. 5 is a schematic chart of the data saving process and a data restoration process which are executed by the information processing apparatus 1. As shown in FIG. 5, files having the system attribute (system data) and files having the user attribute (user data) are stored in the storage section 13. A file “SysConfig1” having the system attribute is stored at a location “C:\OS\System\Config\SysConfig1,” for example. A file “TextFile1” having the user attribute is stored at a location “C:\Users\UserName\Document\TextFile1,” for example.

At step S109, the storage destination of the file (e.g., “SysConfig1”) having the system attribute is changed to under “C:\Users\UserName,” that is, to “C:\Users\UserName\DISK_C\OS\System\Config\SysConfig1,” for example. At step S115, the storage destination of the file (e.g., “TextFile1”) having the user attribute is not changed (remains the ordinary one), that is, it is set to “C:\Users\UserName\Document\TextFile1.”

As described above, when a failure has occurred in the ordinary OS, the information processing apparatus 1 boots the failure recovery OS in response to a user instruction and saves data stored in the storage section 13 by copying them to the external hard disk device 3 under the control of the failure recovery OS. In doing so, the information processing apparatus 1 copies files having the system attribute and files having the user attribute in such a manner that they are discriminated from each other by attaching attribute information to the files and setting storage destinations for the files.

In copying files stored in the storage section 13 to the external hard disk drive 3, it is desirable not to copy ACL (access control list) information for the following reason. The user or group definition state at the time of file restoration may be different from that at the time of file saving. If the definition states are different, it becomes impossible to access the files.

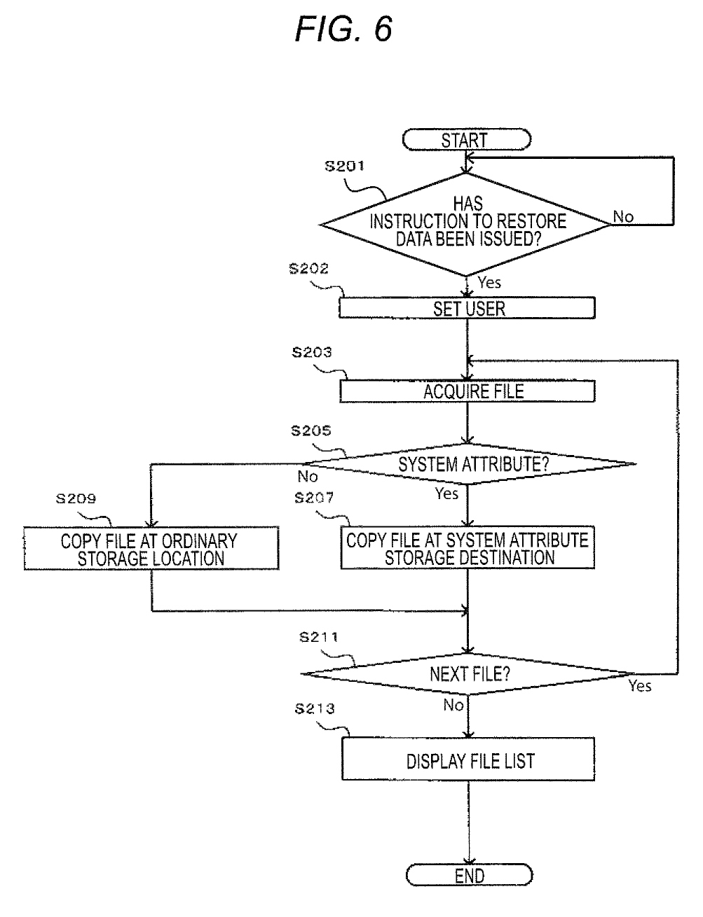

If the information processing apparatus 1 did not recover from the failure in the ordinary OS in spite of the execution of steps S101-S119, the information processing apparatus 1 executes the data restoration process for restoring the data of the storage section 13 on the basis of the data that were copied to the external hard disk drive 3 at step S107 and S113. The data restoration process which is executed by the information processing apparatus 1 will be described below with reference to a flowchart of FIG. 6 and the schematic chart of FIG. 5. It is assumed that the external hard disk drive 3 is connected to the information processing apparatus 1.

If the information processing apparatus 1 attempted to recover from a failure in the ordinary OS but failed to do so and the ordinary OS is returned to the initial state, the data that were stored in the storage section 13 are deleted. Therefore, a user issues an instruction to restore data of the storage device 13 by, for example, making an input through the keyboard 16. At step S201, the control section 11 judges whether an instruction to restore data has been issued by the user. If no instruction to restore data has been issued yet (S201: no), the control section 11 stands by until such an instruction is issued.

If an instruction to restore data has been issued (S201: yes), at step S202 the control section 11 sets a user of the information processing apparatus 1. For example, the control section 11 sets a user on the basis of a user input through the keyboard 16.

At step S203, the control section 11 acquires a file from the external hard disk drive 3 which is connected to the information processing apparatus 1. At step S205, the control section 11 judges whether the attribute of the file acquired at step S203 is the system attribute. The control section 11 judges that the file attribute is the system attribute if the file acquired at step S203 is a file for which the system attribute was set at step S111.

If the file acquired at step S203 has the system attribute (S205: yes), at step S207 the control section 11 copies this file at a system attribute storage location. The control section 11 copies this file while attaching the system attribute to it. If the file acquired at step S203 does not have the system attribute (S205: no), at step S209 the control section 1 copies this file at a user attribute storage location. The control section 11 copies this file while attaching the user attribute to it.

If the storage destination of a file (e.g., “SysConfig1”) having the system attribute was set to “C:\Users\UserName\DISK_C\OS\System\Config\SysConfig1” at step S109 (see FIG. 5) and user “A” was set at step S202, at step S207 this file having the system attribute is copied at the thus-set storage location “C:\Users\A\DISK_C\OS\System\Config\SysConfig1” rather than an ordinary storage location of the file having the system attribute.

If the storage destination of a file (e.g., “TextFile1”) having the user attribute was set to “C:\Users\UserName\Document\TextFile1” at step S115 and user “A” was set at step S202, at step S209 this file having the user attribute is copied ordinarily at the storage location “C:\Users\A\Document\TextFile1.”

After copying the file at step S207 or S209, the control section 11 judges at step S211 whether the next file exists, that is, there remains a file that has not been subjected to steps S203-S209. If the next file exists (S211: yes), the process returns to step S203, where the control section 111 acquires the next file. Then, the control section 111 executes steps S205-S209 again.

If no next file exists (S211: no), that is, if all the subject files stored in the external hard disk drive 3 have been subjected to steps S203-S209, the control section 11 displays a list of all files that were copied (restored) at step S207 and S209. Then, the control section 11 finishes the data restoration process.

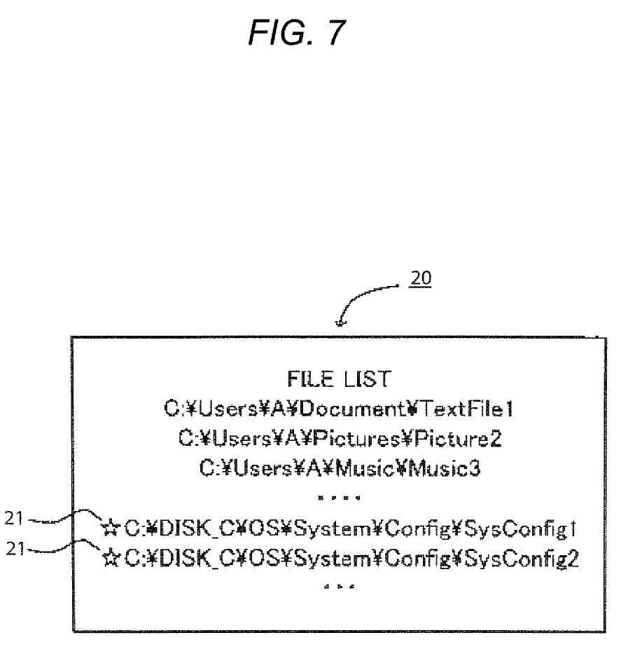

Usually, the default setting is such that files having a hidden attribute such as the system attribute are not displayed in a file list, and hence the user cannot recognize whether these files have been restored normally. In view of this, when a file list indicating a restoration result is displayed at step S213, it is preferable to increase their visibility by attaching a special mark to them. For example, as shown in FIG. 7, when a file list is displayed on the display screen 20 of the display 15, it is preferable to display files having a hidden attribute with an identifier 21 such as a star mark attached to them. Alternatively, files having a hidden attribute in a restoration result may be copied to an easy-to-see place such as the desktop.

As described above, in the information processing apparatus 1, when the OS has been returned to the initial state because of occurrence of a failure in the OS, data that were copied from the storage section 13 to the external hard disk drive 3 before the initialization are copied back to the storage section 13, whereby the data are restored. In doing so, the information processing apparatus 1 sets the storage destinations of files having the system attribute to storage destinations that are different from their original storage locations in the storage section 13, which prevents overwriting with the files having the system attribute.

In the information processing apparatus 1, in one restoration operation, data of only one user among saved data are restored as data of the user who has issued an instruction to perform the restoration operation. Therefore, to restore data of plural users, an appropriate procedure is to cause each user to log on and then perform a restoration operation on data of the user.

In the embodiment, the copying destination of files to be saved is the external hard disk drive 3. However, the invention is not limited to such a case. A configuration is possible in which the information processing apparatus 1 incorporates plural hard disks and one of them is employed as a copying destination of files to be saved. In this case, the copying destination of the files to be saved is set to a hard disk that is different from the hard disk where the ordinary OS is stored. This is because the data stored in the hard disk where the ordinary OS is stored may be deleted when the ordinary OS is initialized.

In the embodiment, user data under “C:\Users” are subjects of copying (saving). However, the invention is not limited to such a case. Arbitrary files or folders maybe set as subjects of copying (saving) by a user's selecting them through the keyboard 16.

In the embodiment, each file has attribute information such as the user attribute or the system attribute. However, the invention is not limited to such a case. A configuration is possible in which attribute information is attached to only system attribute files and files not having attribute information are judged user attribute files. In this case, no attribute information is given to a file that is copied at step S209.

In the information processing apparatus 1, its data restoring method, and its data restoring program according to the invention, when internal data are saved because of occurrence of a failure in the OS, files having the system attribute are stored so as to be discriminated from the other files. When the data are restored, the files having the system attribute are restored while their storage destinations are changed from their original storage locations. This prevents overwriting of the files having the system attribute and thereby makes it possible to reliably save and safely restore internal data.

In general information processing apparatus, when files are restored because of occurrence of a failure in the OS, the files are restored at the same storage locations as their storage locations at the time of saving. However, where the file name of a file is meaningful, the system may be rendered unfunctional if the file is renamed without sufficient consideration. Furthermore, if a file is restored through overwriting at the same storage location as its storage location at the time of saving using the same file name, the system operation may be changed contrary to a user's intention. In view of these, in the information processing apparatus 1 according to the invention, files that may change the system operation (i.e., files having the system attribute) are restored intentionally at storage locations that are different from their storage locations at the time of saving.

The embodiment of the invention is directed to the case that the functions for realizing the invention are stored inside the information processing apparatus 1. However, the invention is not limited to such a case. The same functions may be downloaded to the apparatus via the communication interface 7 or installed in the apparatus from a recording medium.

The information processing apparatus, the data restoring method of an information processing apparatus, and the data restoring program of an information processing apparatus according to the invention make it possible to reliably save and safely restore internal data in the event of an OS failure.

What is claimed is:

1. An information processing apparatus comprising:
a first storage module;
a second storage module;
a first acquiring module configured to acquire data from the first storage module when a failure occurs;
a determination module configured to determine whether the data acquired by the first acquiring module includes system data having a possibility of changing system operation; and
a first copying module configured to copy the data to the second storage device with a destination information,
wherein, when the determination module determines that the data does not include the system data, a previous location of the data before occurrence of the failure is set as the destination information, and
wherein, when the determination module determines that the data includes the system data, a certain location in the first storage module is set as the destination information.

2. The information processing apparatus according to claim 1 further comprising:
a second acquiring module configured to acquire the data from the second storage module when initialization of the first storage module for resolving the occurred failure is completed; and
a second copying module configured to copy the data acquired by the second acquiring module to the first storage module in accordance with the destination information.

3. An information processing apparatus comprising:
a first storage module;
a second storage module;
a first acquiring module configured to acquire data from the first storage module when a failure occurs;
a determination module configured to determine whether the data acquired by the first acquiring module includes system data having a possibility of changing system operation; and
a first copying module configured to copy the data to the second storage device with an attribute information,
wherein, when the determination module determines that the data does not include the system data, a user attribution is set as the attribute information, and
wherein, when the determination module determines that the data includes the system data, a system attribution is set as the attribute information.

4. The information processing apparatus according to claim 3 further comprising:
a second acquiring module configured to acquire the data from the second storage device after initialization of the first storage module for resolving the occurred failure; and
a second copying module configured to copy the data acquired by the second acquiring module to the first storage module at a previous location of the data before occurrence of the failure when the data has the user attribute, and configured to copy the data acquired by the second acquiring module to the first storage module at a certain location when the data has the system attribute.

5. An information processing apparatus comprising:
a first storage module;
a second storage module;
a acquiring module configured to copy the data stored in the first storage module to the second storage module when a failure occurs and configured to acquire the copied data from the second storage module after initialization of the first storage module for resolving the occurred failure;
a determination module configured to determine whether the data acquired by the first acquiring module includes system data having a possibility of changing system operation; and
a copying module configured to copy the acquired data to the first storage module at a previous location of the data before occurrence of the failure when the determination module determines that the acquired data does not include the system data, and configured to copy the acquired data to the first storage module at a certain location when the determination module determines that the acquired data includes the system data.

6. The information processing apparatus according to claim 5 further comprising a display module configured to display a list of the copied data,
wherein the data including the system data is marked on the list.

7. The information processing apparatus according to claim 1, wherein the second storage device includes an external storage device which is detachable from the information processing apparatus.
